(19) United States
(12) Patent Application Publication
(10) Pub. No.: US 2026/0080666 A1
(43) Pub. Date: Mar. 19, 2026

(54) LEARNING APPARATUS, LEARNING METHOD, AND NON-TRANSITORY COMPUTER READABLE MEDIUM

(71) Applicant: Canon Medical Systems Corporation, Otawara-shi (JP)

(72) Inventor: Hidenori TAKESHIMA, Tokyo (JP)

(73) Assignee: Canon Medical Systems Corporation, Otawara-shi (JP)

(21) Appl. No.: 19/309,903

(22) Filed: Aug. 26, 2025

(30) Foreign Application Priority Data
Sep. 19, 2024 (JP) 2024-162312

(51) Int. Cl. G06V 10/774; G06N 3/0455; G06T 3/40; G06T 5/60; G06T 11/00; G06V 10/82

(52) U.S. Cl. CPC G06V 10/774; G06N 3/0455; G06T 3/40; G06T 5/60; G06T 12/20; G06V 10/82; G06T 2207/10081; G06T 2207/10088; G06T 2207/20081; G06T 2207/20084; G06T 2211/424; G06T 2211/441

(57) ABSTRACT

According to one embodiment, a learning apparatus includes processing circuitry. The processing circuitry is configured to obtain a first training data set, the first training data set is based on target data items and having a first resolution. The processing circuitry is configured to train a first machine learning model using the first training data set to generate a first trained model. The processing circuitry is configured to train a second machine learning model using a second training data set and the first trained model to generate a second trained model, the second training data set is based on the target data items and having a second resolution higher than the first resolution.

### CROSS-REFERENCE TO RELATED APPLICATION

This application is based upon and claims the benefit of priority from Japanese Patent Application No. 2024-162312, filed Sep. 19, 2024, the entire contents of which are incorporated herein by reference.

### FIELD

Embodiments described herein relate generally to a learning apparatus, a learning method, and non-transitory computer readable medium.

### BACKGROUND

With the advancement of machine learning, applications of machine learning models in the medical field are advancing. In general, techniques for training a machine learning model include supervised learning and unsupervised learning (including self-supervised learning). In supervised learning, if a large amount of training data is available, high-performance training and high-speed inference can be performed; however, there are cases where a sufficient amount of training data cannot be acquired. In addition, so-called hallucination, that is, outputting of false information as if it were true, depending on the situation, often occurs.

In an image reconstruction process, it is thus realistic to train a machine learning model using unsupervised learning such as self-supervised learning, but this is problematic in that the reconstruction process takes time, since the training is performed on-site at the time of use of the machine learning model.

### BRIEF DESCRIPTION OF THE DRAWINGS

FIG. 1 is a block diagram showing a learning apparatus according to the present embodiment.

FIG. 2 is a conceptual diagram illustrating a difference in resolution between training data sets.

FIG. 3 is a flowchart showing an operation example of a learning apparatus according to the present embodiment.

FIG. 4 is a conceptual diagram illustrating a first example of a configuration of a machine learning model according to the present embodiment.

FIG. 5 is a conceptual diagram illustrating a first example of a configuration of a machine learning model according to the present embodiment.

FIG. 6 is a conceptual diagram illustrating a first example of a configuration of a machine learning model according to the present embodiment.

FIG. 7 is a conceptual diagram illustrating a first example of a configuration of a machine learning model according to the present embodiment.

FIG. 8 is a conceptual diagram illustrating a second example of a configuration of a machine learning model according to the present embodiment.

FIG. 9 is a conceptual diagram illustrating a second example of a configuration of a machine learning model according to the present embodiment.

FIG. 10 shows an example of employment of a trained model for iterative image reconstruction.

FIG. 11 shows a list of example tasks to which the trained model of the present embodiment is applicable.

### DETAILED DESCRIPTION

In general, according to one embodiment, a learning apparatus includes processing circuitry. The processing circuitry is configured to obtain a first training data set, the first training data set is based on target data items and having a first resolution. The processing circuitry is configured to train a first machine learning model using the first training data set to generate a first trained model. The processing circuitry is configured to train a second machine learning model using a second training data set and the first trained model to generate a second trained model, the second training data set is based on the target data items and having a second resolution higher than the first resolution.

Hereinafter, a learning apparatus, a learning method, and a learning program storing in a non-transitory computer readable medium according to the present embodiment will be described with reference to the accompanying drawings. In the embodiments to be described below, portions denoted by the same reference numerals are assumed to perform similar operations, and repetitive descriptions will be suitably omitted. Hereinafter, an embodiment will be described with reference to the accompanying drawings.

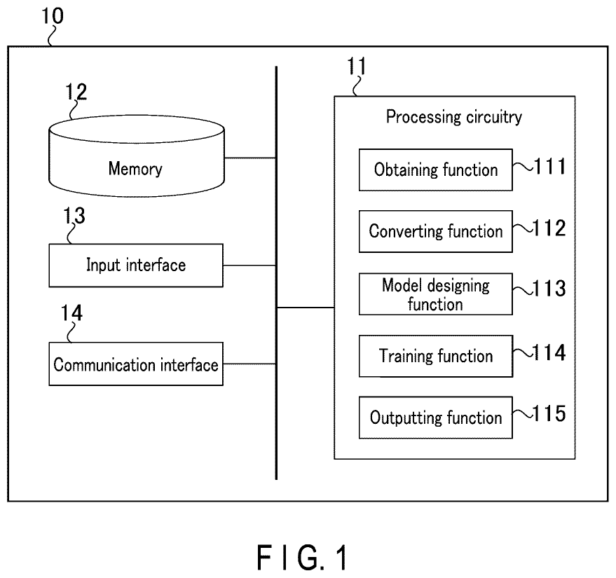

A learning apparatus according to the present embodiment will be described with reference to a block diagram shown in FIG. 1.

A learning apparatus 10 according to the present embodiment includes processing circuitry 11, a memory 12, an input interface 13, and a communication interface 14.

The learning apparatus 10 according to the present embodiment may be included in a console, a workstation, or the like, or may be included in a medical image diagnosis apparatus such as a magnetic resonance imaging (MRI) apparatus or an X-ray computed tomography (CT) apparatus. Alternatively, the learning apparatus 10 may be stored in a server, instead of a local terminal.

The processing circuitry 11 includes an obtaining function 111, a converting function 112, a model designing function 113, a training function 114, and an outputting function 115. The processing circuitry 11 includes a processor (not illustrated) as a hardware resource.

The obtaining function 111 obtains a plurality of items of target data. The plurality of items of target data are, for example, a plurality of items of medical data. Example types of the medical data include k-space data and MR images acquired by an MRI apparatus, and projection data, sinogram data, and CT images acquired by an X-ray CT apparatus. Also, the obtaining function 111 obtains a plurality of training data sets into which each of the plurality of items of target data has been converted by the converting function 112. Note that the types of the medical data are not limited to the data acquired by an MRI apparatus, an X-ray CT apparatus, etc., and may be data acquired by other image diagnosis apparatuses such as an ultrasound diagnosis apparatus.

The converting function 112 converts each of the plurality of items of target data into a plurality of training data sets with different resolutions. In the case of k-space data, a single training data set includes a plurality of items of partial data corresponding to a plurality of resolutions. That is, a plurality of training data sets with different resolutions can be easily generated in the case of k-space data.

The model designing function 113 designs, for each resolution, a structure of a machine learning model to be trained using a corresponding one of the training data sets.

The training function 114 trains the machine learning model designed by the model designing function 113 using the training data set. The machine learning model is, for example, a neural network configured of a deep neural network such as a deep convolutional neural network. The machine learning model may be a U-Net, which is an example of an encoder-decoder model, a ResNet, which includes residual blocks, or a DenseNet, which includes Dense blocks. Moreover, the machine learning model may be formed of a MoDL-based or unrolled neural network as disclosed in Non-Patent Literature 1, or may be formed of a recurrent neural network such as a long short-term memory (LSTM), gated recurrent units (GRUs), or the like. Through completion of the training of the machine learning model, a trained model is generated.

The training function 114 trains a plurality of machine learning models with corresponding structures on the plurality of training data sets with different resolutions, thereby generating a plurality of trained models.

The outputting function 115 outputs information on the training statuses of the machine learning models, the trained models, etc. to an external entity.

Various functions of the processing circuitry 11 may be stored in the memory 12 in the form of computer-executable programs. In this case, the processing circuitry 11 can be said to be a processor configured to read programs corresponding to the respective functions from the memory 12 and execute them, thereby realizing the functions corresponding to the programs. In other words, the processing circuitry 11 having read the programs is equipped with a plurality of functions as shown in the processing circuitry 11 of FIG. 1.

With reference to FIG. 1, a case has been described where various functions are realized by a single processing circuit; however, a plurality of independent processors may be combined to configure the processing circuitry 11 in such a manner that the processors execute the programs to realize the respective functions. In other words, the above-described functions may be respectively configured as programs that are executed by a single processing circuit, or a specific function is implemented on a dedicated independent program-execution circuit.

The memory 12 stores various data such as the target data and the training data sets for the respective resolutions, and the trained models. The memory 12 is a random-access memory (RAM), a semiconductor memory element such as a flash memory, a hard disk drive (HDD), a solid-state drive (SSD), an optical disk, etc. The memory 12 may also be a drive device, etc. configured to read and write a variety of information to and from a portable storage medium such as a CD-ROM drive, a DVD drive, a flash memory, or the like.

The input interface 13 includes a circuit configured to accept various instructions and information input from the user. The input interface 13 includes, for example, circuitry related to a pointing device such as a mouse or an input device such as a keyboard. Note that the circuitry included in the input interface 13 is not limited to a physical operational component such as a mouse, a keyboard, or the like. For example, the input interface 13 may include electric signal processing circuitry for receiving an electric signal corresponding to an input operation from an external input device provided separately from the learning apparatus 10, and outputting the received electric signal to various circuits in the learning apparatus 10.

The communication interface 14 executes wired or wireless data exchange with an external device. Structures of the communication method and the interfaces will be omitted, since general communication means may be used.

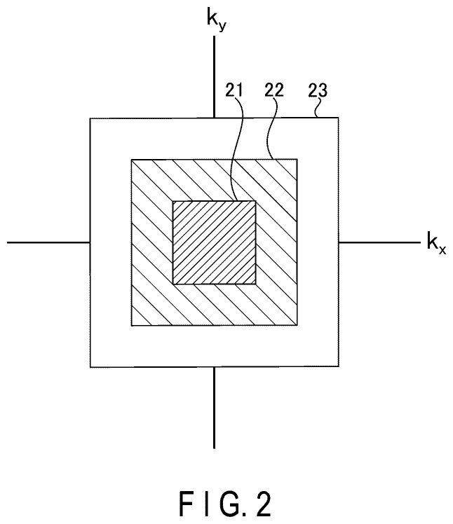

Next, a difference in resolution between training data sets will be described with reference to a conceptual diagram shown in FIG. 2.

FIG. 2 is a conceptual diagram showing k-space in MR data acquisition. In the present embodiment, it is assumed that a “resolution” refers to a spatial resolution. Partial data is configured of data corresponding to a partial region of the k-space, and the larger the partial region, the higher the resolution. With the converting function 112, the processing circuitry 11 extracts (crops) a plurality of items of partial data with different resolutions from each item of target data, thereby generating a plurality of training data sets with different resolutions.

Specifically, in the example of FIG. 2, assuming that the target data (not illustrated) is k-space data acquired for the entire k-space, partial data 21 of the k-space, which includes a central part of the k-space, is k-space data with the lowest resolution. Partial data 22 of a region (data size) larger than the partial data 21, which includes the central part of the k-space and includes a region outside the partial data 21, is k-space data with a higher resolution than the partial data 21. Partial data 23 of a region (data size) larger than the partial data 22, which includes the central part of the k-space and includes a region outside the partial data 22, is k-space data with a higher resolution than the partial data 21 and the partial data 22. It is assumed that levels of resolution are set to a sequence of unit fractions with a power of 2 in the denominator, namely, in descending order of resolution, the target data corresponding to the entire k-space, ½ of the target data, ¼ of the target data, ⅛ of the target data, 1/16 of the target data, etc.; however, the configuration is not limited thereto, and it suffices that multiple levels are set for different resolutions.

If the target data is k-space data, which is assumed to be used for image processing, partial data including a central part of the k-space is extracted, regardless of the resolution, to include low-frequency components.

If the target data is an image such as an MR image, a plurality of training data sets with different resolutions are generated by varying the resolution through image processing on the image. Image processing for converting the resolution is performed with the converting function 112 by the processing circuitry 11 by generating a plurality of images with different resolutions for use as a plurality of training data sets, by using, for example, at least one of a process of degrading the resolution by compressing an original image or a process of improving the resolution by super-resolution imaging, etc.

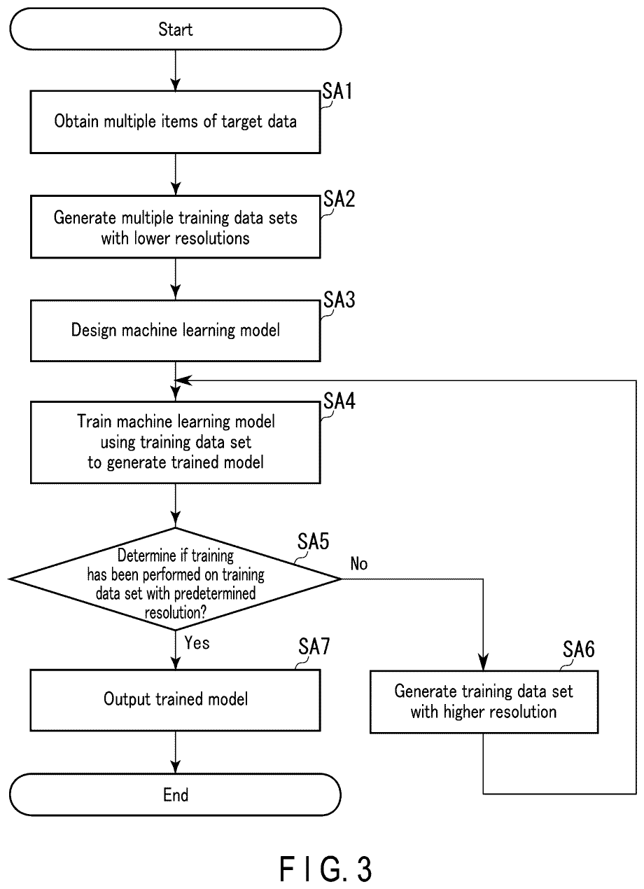

Next, an operation example of the learning apparatus 10 according to the present embodiment will be described with reference to a flowchart shown in FIG. 3.

At step SA1, with the obtaining function 111, the processing circuitry 11 obtains a plurality of items of target data.

At step SA2, with the converting function 112, the processing circuitry 11 converts the plurality of items of target data into a plurality of items of partial data with lower resolutions than the target data, thereby generating a plurality of training data sets. For example, in a first process, partial data of ⅛ the size of the target data is extracted, and thereby a training data set is generated. The number of levels of resolution with which training data sets are to be generated may be determined in advance, or may be determined in accordance with the type of the target data or the task of the machine learning model.

In a first conversion, an item of partial data into which conversion has been performed with a lowest resolution, among a plurality of preset resolutions, is generated as a training data set.

At step SA3, with the model designing function 113, the processing circuitry 11 designs a machine learning model. Specifically, a machine learning model is designed based on information as to what specific architecture is to be used as the machine learning model, and a structure of which part of the entire architecture is to be trained. In second and subsequent processes, the model designing function 113 designs a new machine learning model to include one or more machine learning models that have previously been trained.

At step SA4, with the training function 114, the processing circuitry 11 trains a machine learning model using a training data set, thereby generating a trained model. It is assumed that the training according to the present embodiment is self-supervised learning in which an image is input as the training data set, and training is performed to reproduce the input image; however, either unsupervised learning or supervised learning may be employed instead. Completion of the training of the machine learning model may be determined upon completion of a predetermined number of epochs of learning, or upon determination that a loss value of a loss function is equal to or lower than a threshold value. If the training is completed, updating of parameters is stopped, and a trained model is generated. On the other hand, if the training has not yet been completed, similar processing is repeated until, for example, the training is determined to be completed as described above.

At step SA5, with the training function 114, the processing circuitry 11 determines whether or not the machine learning model has been trained on a training data set with a predetermined resolution. Herein, it is determined whether or not the training has been performed using a training data set with a highest level of resolution, among a plurality of levels of resolution set in advance. If, for example, the training has been performed using the target data of a full size, it may be determined that the machine learning model has been trained on a training data set with a predetermined resolution. In the case where, for example, the highest resolution is set to ½ the size of the target data, namely, a ½ resolution, it may be determined that the machine learning model has been trained on a training data set with a predetermined resolution if the training has been performed using a training data set with the ½ resolution.

If the machine learning model has been trained on a training data set with the predetermined resolution, the processing advances to step SA7, and if the machine learning model has not been trained on a training data set with the predetermined resolution, the processing advances to step SA6.

At step SA6, with the converting function 112, the processing circuitry 11 generates a training data set with a higher resolution than the training data set on which the most recent training has been completed. For example, if, in the first process, a training data set with a ⅛ resolution of the target data has been generated, a training data set with a ¼ resolution of the target data is generated in the second process.

Thereafter, the processing reverts to step SA3, where similar processing is repeated. At step SA3 in the second and subsequent processes, with the model designing function 113, the processing circuitry 11 designs a structure of a new machine learning model to include at least a part of the structure of the trained model. If, for example, a multilayer perceptron (MLP) head corresponding to the task is connected as an output layer of the machine learning model, the configuration of the trained model other than the MLP head may be included in the new machine learning model.

At step SA4 in the second or subsequent processes, with the training function 114, the processing circuitry 11 performs transfer learning on a new machine learning model based on parameters of the trained model, using a training data set which is based on the same target data and which has a higher resolution than that in the previous processing. Specifically, in the case of, for example, a hierarchical multiscale model such as U-Net, a new machine learning model including blocks whose parameters are fixed to those of a trained model is trained.

At step SA7, with the outputting function 115, the processing circuitry 11 outputs a trained model which has been trained up to a predetermined resolution.

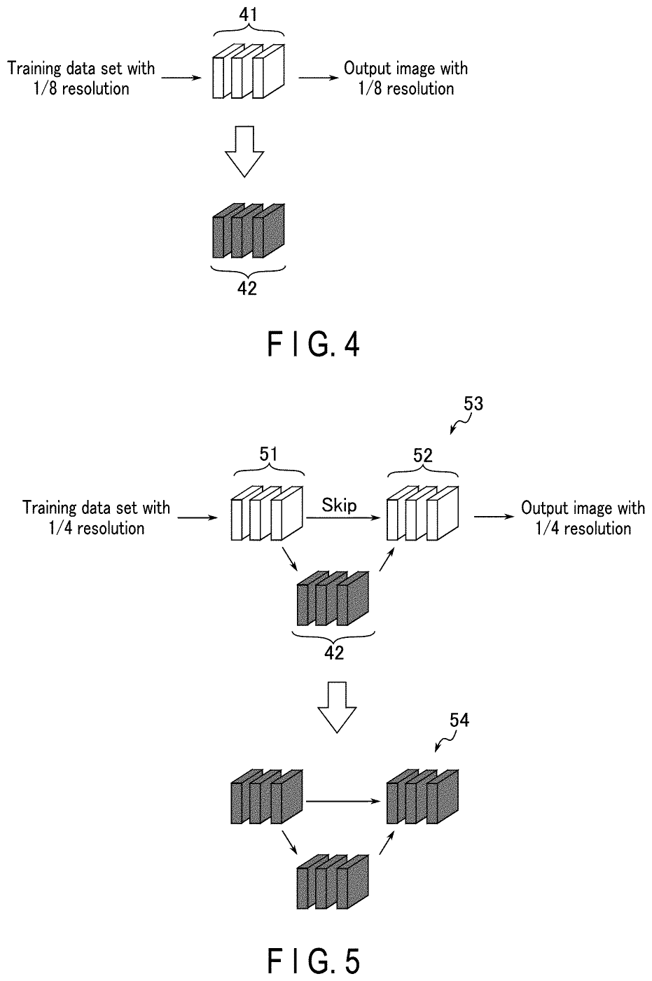

Next, a first example of a configuration of a machine learning model to be trained in a learning apparatus 10 according to the present embodiment will be specifically described with reference to FIGS. 4 to 7. The first example is a training technique assuming a U-Net. In a U-Net, downsampling is performed at an encoder part, and upsampling is performed at a decoder part. At each scale, a skipped connection is provided to allow feature maps of the encoder part to be concatenated to feature maps for upsampling.

It is assumed herein that, for training, training data sets are prepared with four scales: ⅛, ¼, ½, and the full size of the target data, namely, with four levels of resolution.

First, as shown in FIG. 4, a machine learning model 41 is trained using a training data set with a ⅛ resolution of the target data, which is the lowest resolution set with respect to the target data, and a trained model 42 is obtained. As an example, three layers of convolutional blocks for performing convolutional processing are set in the machine learning model 41; however, the configuration is not limited to convolutional blocks, and a model with any architecture may be employed, as long as layers can be stacked in the network or the network can be expanded.

Next, as shown in FIG. 5, with the model designing function 113, the processing circuitry 11 designs, as a new machine learning model 53, a two-stage U-Net in which the trained model 42 for which training has been completed is designed as a feature extraction block at a lowest layer, and feature extraction blocks of an encoder part 51 and a decoder part 52 with a skip connection are set at layers above the feature extraction block at the lowest layer. That is, transfer learning is performed using the trained model as a new machine learning model. In this case, the two-stage U-Net is trained using a training data set with a ¼ resolution of the target data, which is the second-lowest resolution, and a trained model 54 is obtained.

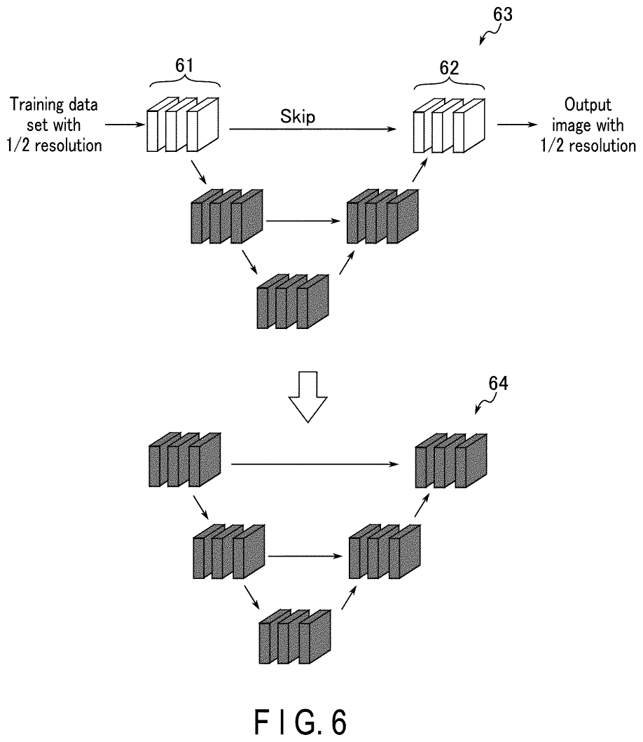

Next, as shown in FIG. 6, with the model designing function 113, the processing circuitry 11 designs, as a new machine learning model 63, a three-stage U-Net in which feature extraction blocks of an encoder part 61 and a decoder part 62 are set at a stage above the trained model 54, which is the two-stage U-Net for which the training has been completed. In this case, the three-stage U-Net is trained using a training data set with a ½ resolution of the target data, which is the third lowest resolution, and a trained model 64 is obtained.

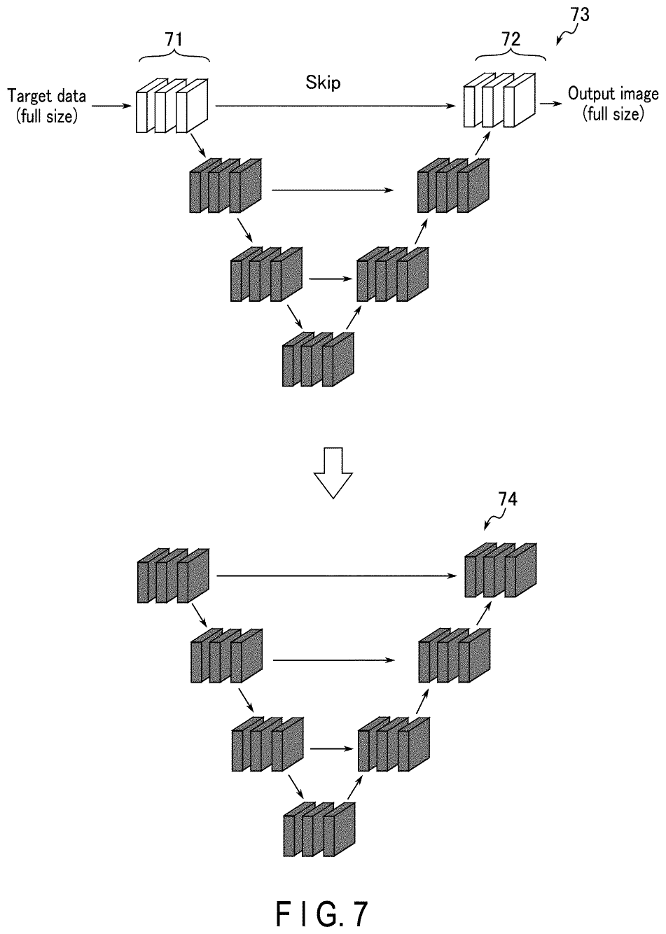

Lastly, as shown in FIG. 7, with the model designing function 113, the processing circuitry 11 designs, as a new machine learning model 73, a four-stage U-Net in which feature extraction blocks of an encoder part 71 and a decoder part 72 are set at a stage above the three-stage U-Net for which the training has been completed. In this case, the four-stage U-Net is trained using, as a training data set, the target data of a full size, which is the highest resolution, and a trained model 74 to be finally output is obtained.

Note that parameters (weights, biases, etc.) of the lower-layer feature extraction blocks for which the training has been completed may be either fixed or used as initial values of the feature extraction blocks at the time of training a new machine learning model.

In the above-described case, a four-stage U-Net has been described based on the assumption that data of ⅛ the size of the target data is the data with the lowest resolution; however, the model can be designed and trained in such a manner that the number of layered structures of the U-Net increases in accordance with the level of resolution set for the target data.

In this manner, after a model of a small scale (architecture) is trained, a model of a next scale is trained by transferring a trained result of the scale for which the training has been completed. That is, a trained result of the model is transferred from a small scale to a large scale, and training is performed in stages to achieve a desired model size. This allows high-speed model training.

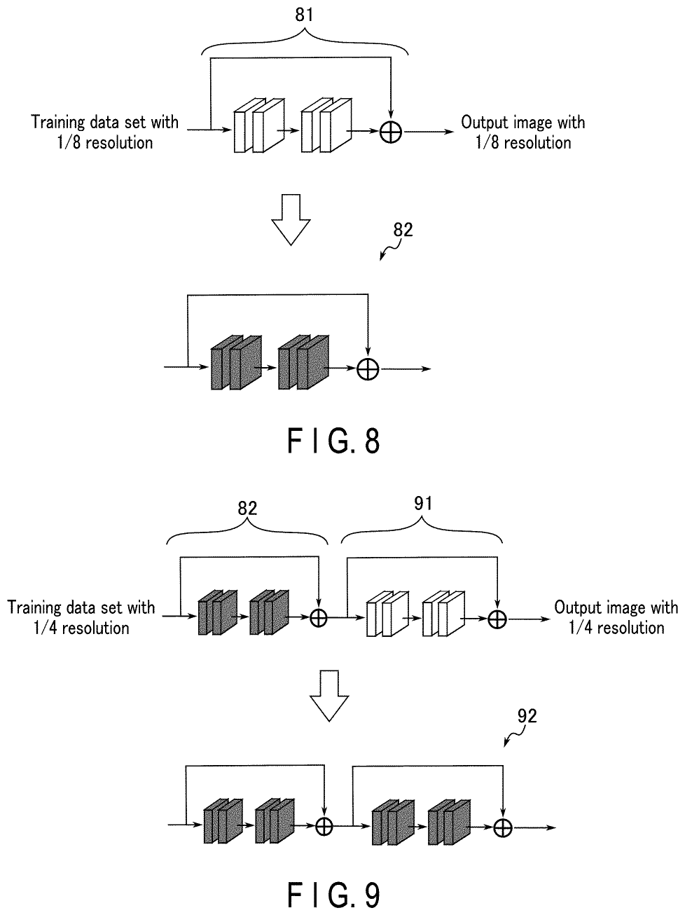

Next, a second example of the learning apparatus 10 according to the present embodiment will be described with reference to FIGS. 8 and 9.

FIG. 8 shows a residual network (ResNet), assuming a configuration in which a plurality of layers of residual blocks are connected in series.

In FIG. 8, a model of a single residual block 81 is trained using a training data set with a lowest resolution set for the target data. In this case, the model of the residual block 81 is trained using a training data set with a ⅛ resolution of the target data, and a trained model 82 is generated.

In FIG. 9, a machine learning model 92 is designed by connecting a new residual block 91 to the trained model 82, and the machine learning model 92 is trained using a training data set with a second-lowest resolution. In this case, the machine learning model 92 is trained using a training data set with a ¼ resolution, which is the second lowest.

After that, according to the level of resolution, a new machine learning model is designed by connecting in series a new residual block after the trained model for which the training has been completed, and the new machine learning model is trained. Note that parameters of the lower-layer feature extraction blocks for which the training has been completed may be handled similarly to the first example of the training method.

In the examples of FIGS. 8 and 9, a case is shown where residual blocks are connected in series at a later stage; however, residual blocks may be sequentially connected in series prior to the residual block for which the training has been completed. That is, for example, a residual block to be trained on a training data set with a ¼ resolution may be connected in series prior to a residual block which has been trained using a training data set with a ⅛ resolution of the target data.

With the learning apparatus according to the present embodiment, the trained model obtained in the above-described manner can be employed for, for example, iterative image reconstruction.

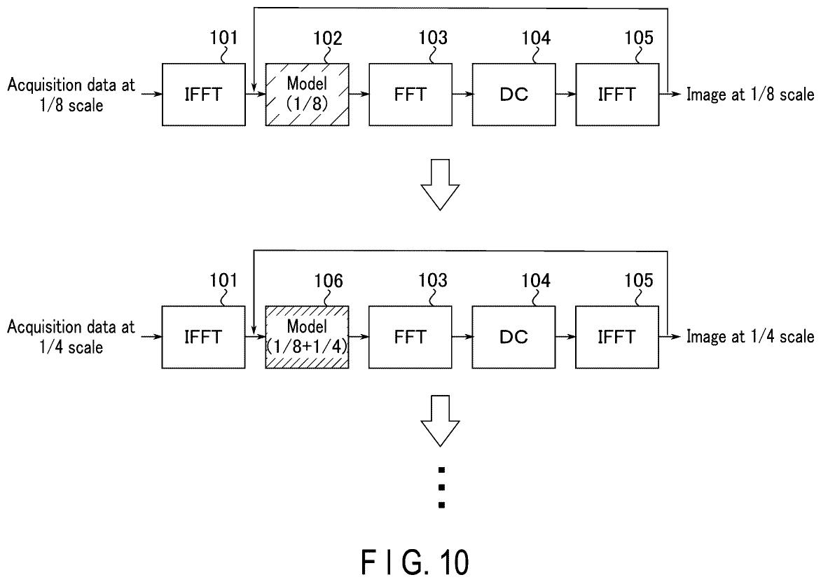

An example of employing a trained model for iterative image reconstruction will be described with reference to FIG. 10.

FIG. 10 shows an example of a conceptual diagram showing iterative image reconstruction with processing blocks. The iterative image reconstruction is a technique of iteratively performing an image reconstruction process with noise reduction using a neural network, while keeping data consistency between target data and an output from a trained model. In the present embodiment, the target data is acquisition data, and may be, if an MRI apparatus is the target, an MR signal itself acquired by the MRI apparatus (e.g., raw data), k-space data in which an acquired MR signal is arranged in k-space, data subjected to signal processing with a filter, etc., or an MR image into which k-space data is converted.

In most cases, iterative image reconstruction can be formulated as an image optimization problem. For example, assuming that the acquisition data is y, a search process of an image x that minimizes the following formula (1) is performed.

$$\hat{x} = arg {min}_{x} \{ {‖ y - Ax ‖}_{2}^{2} + λ R ( x ) \} \qquad ( 1 )$$

Here, “A” represents a transformation of an image into k-space, and the image x is transformed into k-space data by “Ax”. As “A”, a discrete Fourier transform (DFT), a non-uniform discrete Fourier transform (NUDFT), or each of the transforms multiplied from the right by a transform corresponding to the sensitivity of each receive coil in multi-coil data acquisition, for example, can be employed. By reducing a squared error between “Ax” and the acquisition data y, in the case where the acquisition data y is k-space data, the error of the k-space data Ax from the k-space data y is reduced. “λR(x)” represents an error term for an output value of a noise reduction process. “λ” represents a parameter related to the error term, and is a value learned in the course of training of a machine learning model. The formula (1) may be optimized using a known technique such as variable splitting with quadratic penalty (VSQP) or an alternate direction method of multipliers (ADMM), and a detailed description thereof will be omitted.

Note that noise reduction is not essential in iterative image reconstruction, and a trained model may be generated by executing an optimization process of increasing a degree of match between an output of a machine learning model and target data of a training data set.

A case will be described where the method of training a machine learning model by the learning apparatus 10 according to the present embodiment is applied to iterative image reconstruction. In the example of FIG. 10, partial data at ⅛ the scale of the acquisition data, namely, partial data with a ⅛ resolution compared to the full-size acquisition data, is used as a first training data item. With the training function 114, the processing circuitry 11 trains a model 102, which is a machine learning model as shown in FIG. 4, for example, using a first training data set, which is a set of first training data items generated from a plurality of items of acquisition data, in a framework of iterative image reconstruction.

Specifically, in the example of FIG. 10, acquisition data obtained by an MRI apparatus, which is k-space data in this example, is subjected to an inverse fast Fourier transform 101 (IFFT 101), and an image is generated. The generated image is input to the model 102, and a noise-reduced image is generated. The noise-reduced image is subjected to fast Fourier transform 103 (FFT 103), and k-space data is generated. An optimization process of increasing a degree of match between the generated k-space data and the acquisition data (i.e., a data consistency process; shown as DC 104 in FIG. 10) is executed. By subjecting the result of processing at DC 104 to an inverse fast Fourier transform 105 (IFFT 105), an image subjected to the data consistency process is generated. The image subjected to the data consistency process is input to the model 102 again, and the same process is iterated to optimize an image to be output from the IFFT 105.

If the training of the model 102 has been completed, partial data at ¼ the scale of the acquisition data, which has a higher resolution than the first training data set, which is at ⅛ the scale, namely, partial data with a ¼ resolution, as a second training data item. With the training function 114, the processing circuitry 11 trains a model 106 including a model 102, which is a machine learning model as shown in FIG. 5, for example, using a second training data set, which is a set of second training data items generated from a plurality of items of acquisition data, in the above-described framework of iterative image reconstruction, similarly to the case of the first training data set. Thereafter, with the training function 114, the processing circuitry 11 trains the model by increasing the resolution of the training data set and enlarging the configuration of the model until a desired resolution is achieved.

Here, if the input data is MR data, the noise to be the target of the noise reduction process includes, but is not limited to, noise caused by data acquisition, noise caused by signal processing on MR signals, noise caused by data processing on k-space data or spectra, and other artifacts, in addition to the noise caused by non-uniformity of the static magnetic field. Also, if the input data is CT data, the noise to be the target of the noise reduction process includes, but is not limited to, noise caused by data acquisition such as metal artifacts and low-count artifacts.

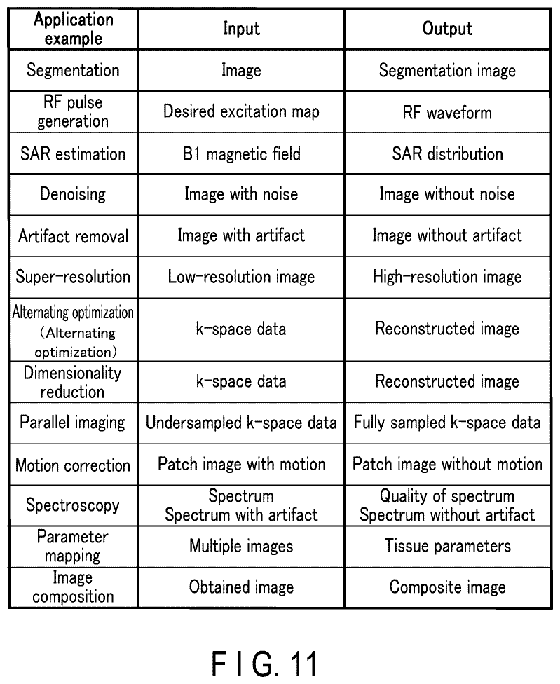

As an example, an iterative reconstruction process has been described; however, processing of a trained model obtained by the learning apparatus according to the present embodiment is not limited thereto. A list of example tasks to which the trained model of the present embodiment is applicable is shown in FIG. 11.

The list of FIG. 11 shows a relationship between application examples of the trained model and their inputs and outputs.

For example, applications include a segmentation process of a medical image. In the case of a segmentation process, training is performed by preparing, with a low resolution (as reduced data), both input data to a trained model and correct data. Applications also include a disease identification task. In the case of a disease identification task, training is performed in sequence from low-resolution images (e.g., partial images) to high-resolution images, before making a final output. That is, the trained model according to the present embodiment is applicable to various processes for increasing the precision or quality of data, and/or increasing the image quality.

In addition, the trained model according to the present embodiment is applicable not only to the examples shown in FIG. 11, but also to outputting of surgical procedure recommendations, clinical decision support (CDS), cancer stage grading, and the like.

According to the present embodiment described above, a learning apparatus is configured to train a machine learning model using a first training data set with a first resolution, thereby generating a trained model. The learning apparatus is configured to train a new machine learning model including a trained model by transfer learning, namely, using a second training data set which is based on the same target data as the first training data set and which has a second resolution higher than the first resolution. The learning apparatus is configured to execute the transfer learning until a desired resolution is achieved, thereby generating a trained model for the target data.

That is, by starting training in a small scale and sequentially transferring the result of the training of the scale for which the training has been completed to a larger scale, it is possible to improve the convergence speed of learning as compared to the case of starting training of a model in a large scale, thereby shortening the model training time.

Furthermore, the functions according to the embodiment may be realized by installing the programs for executing the above-described processes onto a computer such as a workstation, and developing them on a memory. At this time, a program for allowing a computer to execute the above-described technique may be stored and distributed in a storage medium such as a magnetic disk (e.g., a hard disk), an optical disk (e.g., a CD-ROM, a DVD, etc.), or a semiconductor memory.

The term “processor” used in the above explanation means, for example, a central processing unit (CPU), a graphics processing unit (GPU), or circuitry such as an application-specific integrated circuit (ASIC) or a programmable logic device (e.g., a simple programmable logic device (SPLD), a complex programmable logic device (CPLD), or a field programmable gate array (FPGA)).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A learning apparatus comprising processing circuitry configured to:
obtain a first training data set, the first training data set being based on target data items and having a first resolution;
train a first machine learning model using the first training data set to generate a first trained model; and
train a second machine learning model using a second training data set and the first trained model to generate a second trained model, the second training data set being based on the target data items and having a second resolution higher than the first resolution.

2. The learning apparatus according to claim 1, wherein
the second machine learning model includes at least a partial configuration of the first machine learning model, and
the processing circuitry is configured to train the second machine learning model based on parameters of the first trained model.

3. The learning apparatus according to claim 1, wherein
the first machine learning model is a part of a U-Net which is an encoder-decoder model, and
the second machine learning model is a U-Net including (a) the first machine learning model and (b) convolutional layers of an encoder and a decoder with a skip connection as an upper layer of the first machine learning model.

4. The learning apparatus according to claim 1, wherein
the first machine learning model includes a residual block, and
the second machine learning model includes a new residual block connected in series to the first machine learning model.

5. The learning apparatus according to claim 1, wherein
the processing circuitry is further configured to convert the target data items into the first training data set with the first resolution, and/or the second training data set with the second resolution.

6. The learning apparatus according to claim 1, wherein
the target data items are k-space data items,
the first training data set includes first data items of a central part of a k-space of the target data items, and
the second training data set includes the first data items and second data items of an outer part of the central part of the k-space of the target data items.

7. The learning apparatus according to claim 1, wherein
the processing circuitry is configured to:
execute an optimization process of increasing a degree of match between a first training data item included in the first training data set and a data item based on an output from the first machine learning model in response to an input of the first training data item, to generate the first trained model; and
execute an optimization process of increasing a degree of match between a second training data item contained in the second training data set and a data item based on an output from the second machine learning model in response to an input of the second training data item, to generate the second trained model.

8. The learning apparatus according to claim 1, wherein
the first machine learning model and the second machine learning model are models designed to reduce noise in data.

9. The learning apparatus according to claim 1, wherein
the first machine learning model and the second machine learning model are trained by unsupervised learning or self-supervised learning.

10. The learning apparatus according to claim 1, wherein
the target data items are one of a magnetic resonance (MR) image, k-space data, projection data, sinogram data, or a computed tomography (CT) image.

11. A learning method, comprising:
obtaining a first training data set, the first training data set being based on target data items and having a first resolution; and
training a first machine learning model using the first training data set to generate a first trained model; and
training a second machine learning model using a second training data set and the first trained model to generate a second trained model, the second training data set being based on the target data items and having a second resolution higher than the first resolution.

12. A non-transitory computer readable medium including computer executable instructions, wherein the instructions, when executed by a processor, cause the processor to perform a method comprising:
obtaining a first training data set, the first training data set being based on target data items and having a first resolution;
training a first machine learning model using the first training data set to generate a first trained model; and
training a second machine learning model using a second training data set and the first trained model to generate a second trained model, the second training data set being based on the target data items and having a second resolution higher than the first resolution.
